(19) United States
(12) Patent Application Publication
(10) Pub. No.: US 2014/0118257 A1
(43) Pub. Date: May 1, 2014

(54) GESTURE DETECTION SYSTEMS

(71) Applicant: Amazon Technologies, Inc., (US)

(72) Inventor: Leo Benedict Baldwin, San Jose, CA (US)

(73) Assignee: Amazon Technologies, Inc., Reno, NV (US)

(21) Appl. No.: 13/663,429

(22) Filed: Oct. 29, 2012

(51) Int. Cl. G06F 3/033

(52) U.S. Cl. 345/158

(57) ABSTRACT

The amount of power and processing needed to enable gesture input for a computing device can be reduced by utilizing one or more gesture sensors. A gesture sensor can have a lower resolution but larger pixel pitch than conventional cameras. The lower resolution can be achieved in part through skipping or binning pixels in some embodiments. The low resolution enables a global shutter to be used with the gesture sensor. The gesture sensor can be connected to an illumination controller for synchronizing illumination from a device emitter with the global shutter. In some devices, the gesture sensor can be used as a motion detector, enabling the gesture sensor to run in a low power state unless there is likely gesture input to process. At least some processing and circuitry is included with the gesture sensor such that functionality can be performed without accessing a central processor or system bus.

### BACKGROUND

People are increasingly interacting with computers and other electronic devices in new and interesting ways. One such interaction approach involves making a detectable motion with respect to a device, which can be detected using a camera or other such element. While image recognition can be used with existing cameras to determine various types of motion, the amount of processing needed to analyze full color, high resolution images is generally very high. This can be particularly problematic for portable devices that might have limited processing capability and/or limited battery life, which can be significantly drained by intensive image processing. Some devices utilize basic gesture detectors, but these detectors typically are very limited in capacity and only are able to detect simple motions such as up-and-down, right-or-left, and in-and-out. These detectors are not able to handle more complex gestures, such as holding up a certain number of fingers or pinching two fingers together.

Further, cameras in many portable devices such as cell phones often have what is referred to as a “rolling shutter” effect. Each pixel of the camera sensor accumulates charge until it is read, with each pixel being read in sequence. Because the pixels provide information captured and read at different times, as well as the length of the charge times, such cameras provide poor results in the presence of motion. A motion such as waiving a hand or a moving of one or more fingers will generally appear as a blur in the captured image, such that the actual motion cannot accurately be determined.

### BRIEF DESCRIPTION OF THE DRAWINGS

Various embodiments in accordance with the present disclosure will be described with reference to the drawings, in which:

FIG. 1 illustrates an example environment in which various aspects can be implemented in accordance with various embodiments;

FIG. 2 illustrates an example computing device that can be used in accordance with various embodiments;

FIGS. 3(a) and 3(b) illustrate a conventional camera sensor and a gesture sensor having a similar form factor that can be used in accordance with various embodiments;

FIGS. 4(a), (b), (c), and (d) illustrate examples of images of a hand in motion that can be captured in accordance with various embodiments;

FIGS. 5(a) and 5(b) illustrate an example of detectable motion in low resolution images in accordance with various embodiments;

FIGS. 6(a) and 6(b) illustrate example images for analysis with different types of illumination in accordance with various embodiments;

FIG. 7 illustrates a first example configuration of components of a computing device that can be used in accordance with various embodiments;

FIG. 8 illustrates a second example configuration of components of a computing device that can be used in accordance with various embodiments;

FIG. 9 illustrates a third example configuration of components of a computing device that can be used in accordance with various embodiments; and

FIG. 10 illustrates an example process for enabling gesture input that can be used in accordance with various embodiments; and

FIG. 11 illustrates an example environment in which various embodiments can be implemented.

### DETAILED DESCRIPTION

Systems and methods in accordance with various embodiments of the present disclosure may overcome one or more of the aforementioned and other deficiencies experienced in conventional approaches to controlling functionality in an electronic environment. In particular, various approaches provide for determining and enabling gesture-and/or motion-based input for an electronic device. Various approaches can be used for head tracking, gaze tracking, or other such purposes as well. Such approaches enable relatively complex gestures to be interpreted with lower cost and power consumption than conventional approaches. Further, these approaches can be implemented in a camera-based sensor subsystem in at least some embodiments, which can be utilized advantageously in devices such as tablet computers, smart phones, electronic book readers, and the like.

In at least one embodiment, a gesture sensor can be utilized that can be the same size as, or smaller than, a conventional camera element, such as ⅓ or ¼ of the size of a conventional camera or less. The gesture sensor, however, can utilize a smaller number of larger pixels than conventional camera elements, and can provide for virtual shutters of the individual pixels. Such an approach provides various advantages, including reduced power consumption and lower resolution images that require less processing capacity while still providing sufficient resolution for gesture recognition. Further, the ability to provide a virtual “global” shutter for the gesture sensor enables each pixel to capture information at substantially the same time, with substantially the same exposure time, eliminating most blur issues or other such artifacts found with rolling shutter elements. The shutter speed also can be adjusted as necessary due to a number of factors, such as device-based illumination and ambient light, in order to effectively freeze motion and provide for enhanced gesture determination. The ability to provide a globally shuttered imager also can greatly increase the effectiveness of auxiliary lighting, such as an infrared (IR) light emitting diode (LED) capable of providing strobed illumination that can be timed with the exposure time of each pixel.

In at least some embodiments, a subset of the pixels (e.g., one or more) on the gesture sensor can be used as a low power motion detector. In other embodiments, subsets of pixels can be read and/or analyzed together to provide a lower resolution image. The intensity at various locations can be monitored and compared, and certain changes indicative of motion can cause the gesture sensor to “wake up” or otherwise become fully active and attempt, at full or other increased resolution, to determine whether the motion corresponds to a gesture. If the motion corresponds to a gesture, other functionality on the device can be activated as appropriate, such as to trigger a separate camera element to perform facial recognition or another such process.

In at least some embodiments, portions of the circuitry and/or functionality can be contained on the chip with the gesture sensor. For example, switching from a motion detection mode to a gesture analysis mode can be triggered on-chip, avoiding the need to utilize a system bus or central processor, thereby conserving power and device resources. Other functions can be triggered from the chip as well, such as the timing of an LED or other such illumination element. In at least some embodiments, a single lane MIPI (mobile industry processor interface) interface can be utilized between the camera and a host processor or other such component configured to analyze the image data. An I²C interface (or similar interface) then can be used to provide instructions to the camera (or camera sub-assembly), such as to communicate various settings, modes, and instructions. In at least some embodiments a separate output from the camera sub-assembly can be used to synchronize illumination, such as an IR LED, with the camera exposure times. When used with a global shutter, the IR LED can be activated for a time that, in at least some embodiments, is at most as long as the exposure time for a single pixel of the camera sensor.

Various other applications, processes and uses are presented below with respect to the various embodiments.

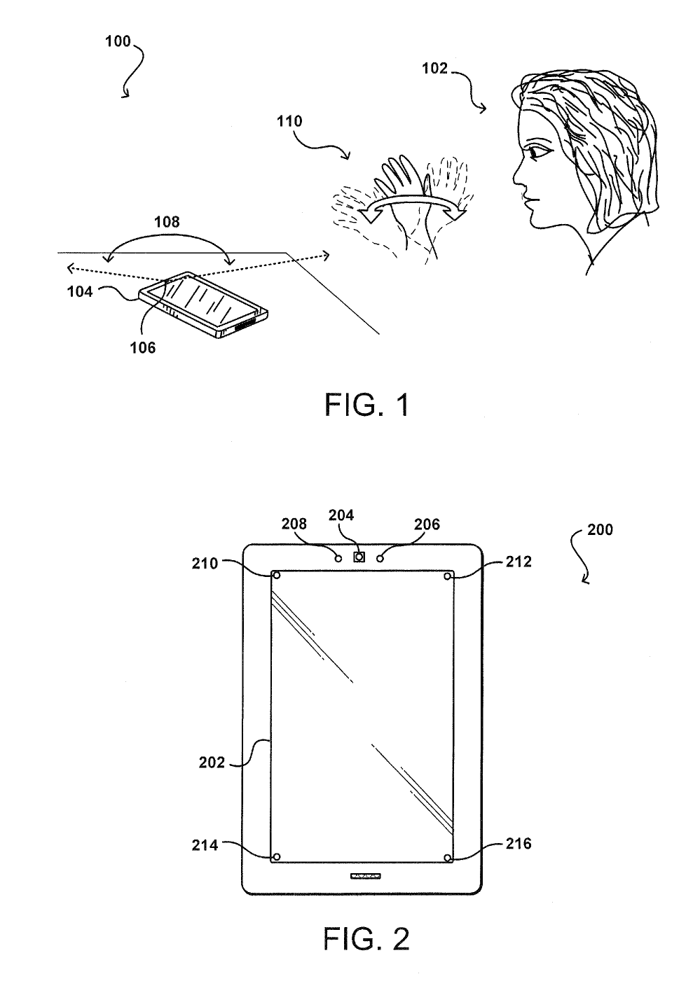

FIG. 1 illustrates an example situation 100 wherein a user 102 would like to provide gesture- and/or motion-based input to a computing device 104. Although a portable computing device (e.g., a smart phone, an electronic book reader, or tablet computer) is shown, it should be understood that various other types of electronic device that are capable of determining and processing input can be used in accordance with various embodiments discussed herein. These devices can include, for example, notebook computers, personal data assistants, cellular phones, video gaming consoles or controllers, and portable media players, among others. In this example, the computing device 104 has at least one image capture element 106 operable to perform functions such as image and/or video capture. Each image capture element may be, for example, a camera, a charge-coupled device (CCD), a motion detection sensor, or an infrared sensor, or can utilize another image capturing technology.

In this example, the user 102 is performing a selected motion or gesture using the user's hand 110. The motion can be one of a set of motions or gestures recognized by the device to correspond to a particular input or action. If the motion is performed within a viewable area or angular range 108 of at least one of the imaging elements 106 on the device, the device can capture image information including the motion, analyze the image information using at least one image analysis or feature recognition algorithm, and determine movement of a feature of the user between subsequent frames. This can be performed using any process known or used for determining motion, such as locating “unique” features in one or more initial images and then tracking the locations of those features in subsequent images, whereby the movement of those features can be compared against a set of movements corresponding to the set of motions or gestures, etc. Other approaches for determining motion- or gesture-based input can be found, for example, in co-pending U.S. patent application Ser. No. 12/332,049, filed Dec. 10, 2008, and entitled “Movement Recognition and Input Mechanism,” which is hereby incorporated herein by reference.

As discussed above, however, analyzing full color, high resolution images from one or more cameras can be very processor, resource, and power intensive, particularly for mobile devices. Conventional complementary metal oxide semiconductor (CMOS) devices consume less power than other conventional camera sensors, such as charge coupled device (CCD) cameras, and thus can be desirable to use as a gesture sensor. While relatively low resolution CMOS cameras such as CMOS VGA cameras (i.e., with 256×256 pixels, for example) can be much less processor-intensive than other such cameras, these CMOS cameras typically are rolling shutter devices, which as discussed above are poor at detecting motion. Each pixel is exposed and read at a slightly different time, resulting in apparent distortion when the subject and the camera are in relative motion during the exposure. CMOS devices are advantageous, however, as they have a relatively standard form factor with many relatively inexpensive and readily available components, such as lenses and other elements developed for webcams, cell phone, notebook computers, and the like. Further, CMOS cameras typically have a relatively small amount of circuitry, which can be particularly advantageous for small portable computing devices, and the components can be obtained relatively cheaply, at least with respect to other types of camera sensor.

Approaches in accordance with various embodiments can take advantage of various aspects of CMOS camera technology, or other such technology, to provide a relatively low power but highly accurate gesture sensor that can utilize existing design and implementation aspects to provide a sensible solution to gesture detection. Such a gesture sensor can be used in addition to a conventional camera, in at least some embodiments, which can enable a user to activate or control aspects of the computing device through gesture or movement input, without utilizing a significant amount of resources on the device.

For example, FIG. 2 illustrates an example computing device 200 that can be used in accordance with various embodiments. In this example, the device has a conventional, “front facing” digital camera 204 on a same side of the device as a display element 202, enabling the device to capture image information about a user of the device during typical operation where the user is at least partially in front of the display element. In addition, there are four gesture sensors 210, 212, 214, 216 positioned on the same side of the device as the front-facing camera. One or more of these sensors can be used, individually, in pairs, or in any other combination, to determine input corresponding to the user when the user is within a field of view of at least one of these gesture sensors. It should be understood that there can be additional cameras, gesture sensors, or other such elements on the same or other sides or locations of the device as well within the scope of the various embodiments, such as may enable gesture or image input from any desired direction or location with respect to the device. A camera and gesture sensor can be used together advantageously in various situations, such as where a device wants to enable gesture recognition at relatively low power over an extended period of time using the gesture sensor, and perform facial recognition or other processor and power intensive processes at specific times using the conventional, higher resolution camera. In some embodiments two of the four gesture sensors will be used at any given time to collect image data, enabling determination of feature location and/or movement in three dimensions. Providing four gesture sensors enables the device to select appropriate gesture sensors to be used to capture image data, based upon factors such as device orientation, application, occlusions, or other such factors. As discussed, in at least some embodiments each gesture sensor can utilize the shape and/or size of a conventional camera, which can enable the use of readily available and inexpensive parts, and a relatively short learning curve since much of the basic technology and operation may be already known.

This example device also illustrates additional elements that can be used as discussed later herein, including a light sensor 206 for determining an amount of light in a general direction of an image to be captured and an illumination element 208, such as a white light emitting diode (LED) or infrared (IR) emitter as will be discussed later herein, for providing illumination in a particular range of directions when, for example, there is insufficient ambient light determined by the light sensor. Various other elements and combinations of elements can be used as well within the scope of the various embodiments as should be apparent in light of the teachings and suggestions contained herein.

As discussed, conventional low-cost CMOS devices typically do not have a true electronic shutter, and thus suffer from the rolling shutter effect. While this is generally accepted in order to provide high resolution images in a relatively small package, gesture detection does not require high resolution images for sufficient accuracy. For example, a relatively low resolution camera can determine that a person is moving his or her hand left to right, even if the resolution is too low to determine the identity whether the hand belongs to a man or a woman.

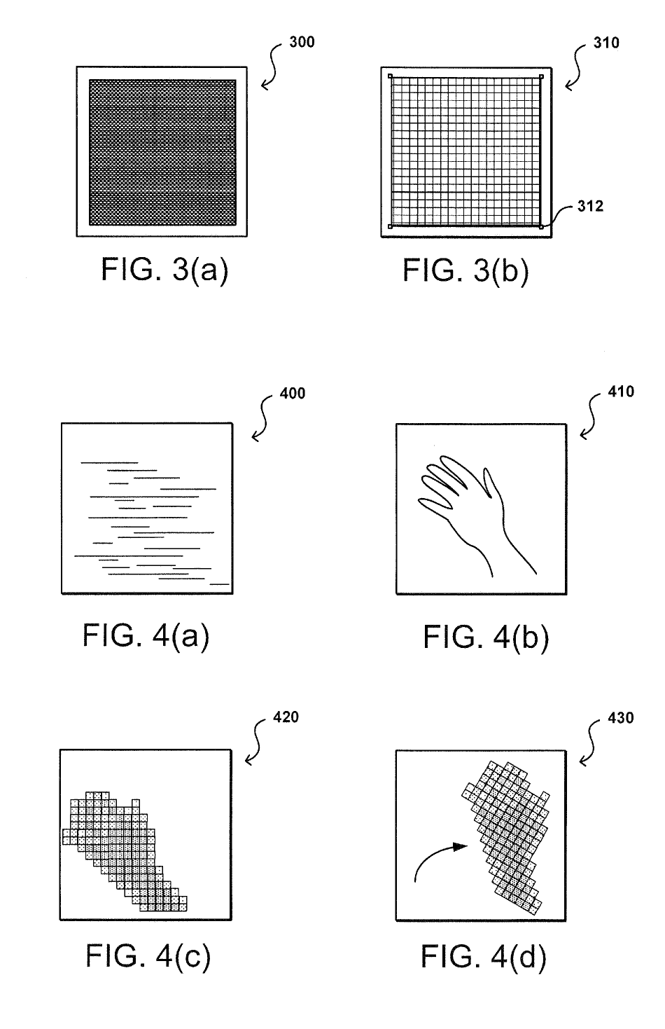

Accordingly, an approach that can be used in accordance with various embodiments discussed herein is to utilize aspects of a conventional camera, such as CMOS camera. An example of a CMOS camera sensor 300 is illustrated in FIG. 3(a), although it should be understood that the illustrated grid is merely representative of the pixels of the sensor and that there can be hundreds to thousands of pixels or more along each side of the sensor. Further, although the sensors shown are essentially square it should be understood that other shapes or orientations can be used as well, such as may include rectangular or hexagonal active areas. FIG. 3(b) illustrates an example of a gesture sensor 310 that can be used in accordance with various embodiments. As can be seen, the basic form factor and components can be similar to, or the same as, for the conventional camera sensor 300. In this example, however, there are fewer pixels representing a lower resolution device. Because the form factor is the same, this results in larger pixel size (or in some cases a larger separation between pixels, etc.). As discussed, however, the gesture sensors can be different in size than the camera sensors, but can still have a smaller number of larger pixels, etc.

In at least some embodiments, a gesture sensor can have a resolution on the order of about 400×400 pixels, although other resolutions can be utilized as well in other embodiments. Other formats may have, but are not limited to, a number of pixels less than a million pixels. It should be understood that smaller form factor sensors with such a number of pixels can be used as well, although it can be advantageous to keep the pixels relatively large, as discussed elsewhere herein. The pixel size can be a combination of the sensor size and number of pixels, among other such factors. In a gesture sensor with a resolution of 400×400 pixels, the pixel pitch can be on the order of about 3.0 microns in one embodiment, which provides a pixel effective area of about 9.0 square microns, where the effective area can be associated with a microlens or other such optical element. In at least some embodiments, the size of the active area of the gesture sensor is about 1.2 millimeters×1.2 millimeters, for an active area on the order of 1.44 square millimeters for the 160,000 or so pixels. The size of a sensor die supporting the camera sensor then can be less than ten square millimeters in at least some embodiments, such as on the order of 3.25 millimeters×3.25 millimeters or less in dimension. Such a resolution in at least some embodiments can provide at least a twenty pixel linear coverage across a typical user face at approximately 1.5 meters in distance when using a wide angle lens, such as a lens having 120 degrees of diagonal coverage in object space. At least one gesture sensor in at least some embodiments can also have an associated RGB Bayer color filter, while at least one gesture sensor might not have an associated filter in at least some embodiments, enabling a panchromatic response for wavelengths from about 350 nanometers to about 1,050 nanometers with maximum sensitivity, including maximum sensitivity in the spectral bands of infra-red light-emitting diodes.

An advantage to having such a relatively smaller number of larger pixels is that global shuttering can be incorporated with the pixels without a need to increase the size, of the die containing the sensor. As discussed, a small die size can be important for factors such as device cost (which scales with die area), device size (which is driven by die area), and the associated lenses and costs (which is driven at least in part by the active area, which is a principle determinant of the die area). It also can be easier to extend the angular field of view of various lens elements (i.e., beyond 60 degrees diagonal) for smaller, low resolution active areas. Further, the ability to use a global shutter enables all pixels to be exposed at essentially the same time, and enables the device to control how much time the pixels are exposed to, or otherwise able to capture, incident light. Such an approach not only provides significant improvement in capturing items in motion, but also can provide significant power savings in many examples. As an example, FIG. 4(a) illustrates in a diagrammatic fashion an example 400 of the type of problem encountered by a rolling shutter camera when trying to capture a waving hand. As can be seen, there is a significant amount of blur or distortion that can prevent a determination of the precise, or even approximate, location of the hand in this frame for comparison against subsequent and/or preceding frames.

The use of a global shutter enables the exposed pixels to capture charge at substantially the same time. Thus, the sensor can have a very fast effective shutter speed, limited only (primarily) by the speed at which the pixels can be exposed and then drained. The sensor thus can capture images of objects, even when those objects are in motion, with very little blur. For example, FIG. 4(b) illustrates an example of an image 410 that can be captured of a hand while the hand is engaged in a waving motion. Due at least in part to the fast shutter speed and the near simultaneous reading of the pixels, the approximate location of the hand at the time of capture of the image can readily be determined.

The use of a global shutter also enables a more effective use of an illuminator such as an IR LED. The LED can be pulsed at very high current for a very short but high-intensity luminous output. The luminous output is integrated simultaneously by the globally shuttered pixels, stored, and then read out serial. This can be more efficient than rolling shutter imagers that expose the pixels sequentially and require that the illuminator be on for the duration of the readout time, thus reducing the peak current that the LED illuminator can be operated at as there is a limit on the current-time product for thermal-effect reasons. Use of the global shutter also can improve control of the ratio between admitted ambient light and admitted illuminant lighting for difficult lighting conditions and to emphasize near-field objects over a distant background. As discussed, the use of a global shutter enables the LED illuminator to be active only during the exposure time of a single pixel in at least some embodiments, and in at least some embodiments the illumination time can be less than the exposure time in order to balance the amount of reflected illumination from the LED illuminator versus ambient light.

As discussed, the ability to recognize such gestures will not often require high resolution image capture. For example, consider the image 420 illustrated in FIG. 4(c). This image illustrates the fact that even a very low resolution image can be used to determine gesture input. In FIG. 4(c), the device might not be able to recognize whether the hand is a man's hand or a woman's hand, but can identify the basic shape and location of the hand in the image such that changes in position due to waving or other such motions, as illustrated in image 430 of FIG. 4(d), can quickly be identified with sufficient precision. Even at this low resolution, the device likely would be able to tell whether the user was moving an individual finger or performing another such action.

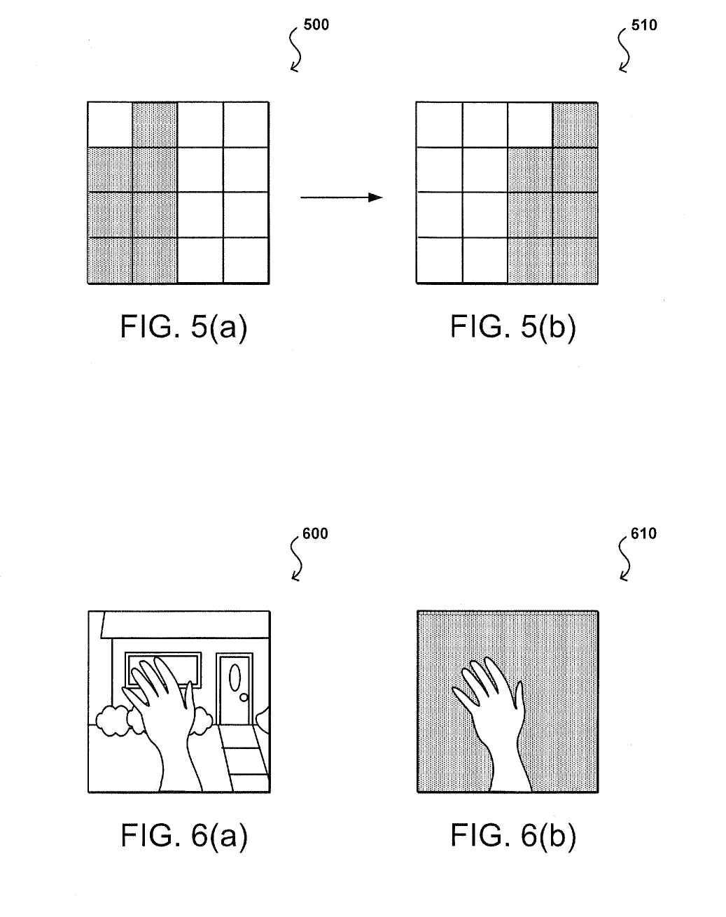

For example, consider the low resolution images of FIGS. 5(a) and 5(b). When a user moves a hand and arm from right to left across a sensor, for example, there will be an area of relative light and/or dark that will move across the images. As illustrated, the darker pixels in the image 500 of FIG. 5(a) are shifted to the right in the image 510 of FIG. 5(b). Using only a small number of pixel values, the device can attempt to determine when features such as the darker pixels move back and forth in the low resolution images. Even though such motion might occur due to any of a number of other situations, such as people walking by, the occurrence can be low enough that using such information as an indication that someone might be gesturing to the device can provide a substantial power savings over continual analysis of even a QVGA image.

The low resolution image can be obtained in any of a number of ways. For example, referring back to the gesture sensor 310 of FIG. 3(b), the device can select to utilize a small subset of these pixels, such as 2, 4, 8, or 16 to capture data at a relatively low frame rate (e.g., two frames per second) to attempt to recognize wake up gestures while conserving power. In other embodiments, there can be a set of extra pixels 312 at the corners or otherwise outside the primary area of the gesture sensor. While such an approach could increase the difficulty in manufacturing the sensor in some embodiments, such an arrangement can provide for simplified control and separation of the “wake up” pixels from the main pixels of the gesture sensor. Various other approaches can be used as well, although in many embodiments it will be desirable to disperse the pixels without increasing the size of the die.

While skipping pixels or only reading a sampling of the pixels might be adequate in certain situations, such as when there is a substantial amount of ambient light, there can be situations where only reading data from a subset of the pixels can be less desirable. For example, if an object being imaged is in a low light situation, an image captured of that object might be noisy or have other such artifacts. Accordingly, approaches in accordance with various embodiments can instead, in at least some embodiments, utilize a binning-style approach wherein each pixel value is read by the camera sensor. Instead of providing all those pixel values to a host processor or other such component for analysis, however, the readout circuitry of the camera sub-assembly can read two or more pixels (i.e., a “group” of pixels) at approximately the same time, where the pixels of a group are at least somewhat adjacent in the camera sensor. The charge of the pixels in the group then can be combined into a single “bucket” (i.e., a charge well, capacitor, or other such storage mechanism), which can increase the charge versus a reading for a single pixel (e.g., doubling the charge for two pixels). Such an approach provides an improvement in signal-to-noise ratio, as the increase in signal will be greater than the increase in noise when combining the pixel values. In at least some embodiments, the combined charge for a group can be divided by the number of pixels in the group, providing an average pixel value for the group. The same process can be used for the next pixel group, which provides another advantage in the fact that noise is random, so the effects of noise will be further by analyzing adjacent groups of pixels separately. The number of pixels in a group can vary by embodiment, as may include two, four, sixteen, or another number of pixels. A binning approach provides lower resolution, but where a lower resolution is acceptable the resulting images can have improved signal to noise versus full (or otherwise higher) resolution images. Further, the improved signal-to-noise ratio enables the LED to be operated for a shorter period of time, or with less intensity, as the resulting noise will have less impact on the captured images.

In some embodiments, data captured by a light sensor or other such mechanism can be used to determine when to utilize binning to improve signal to noise, and in at least some embodiments can be used to determine an amount of illumination to be provided for the detection. In an example where a gesture sensor has a 400×400 pixel resolution with a 3 micron pixel pitch, as presented above, combining four pixels into a pixel group results in an effective resolution of 200×200 pixels, with an effective pixel pitch of six microns and an effective pixel area of about thirty-six square microns. If sufficient lighting is available, or if conditions otherwise allow, a skipping approach can be used where only every other pixel is read, giving an effective resolution of 200×200 pixels, or 100×100 depending on how many pixels are skipped, etc. Skipping approaches can be used advantageously in conditions where noise will likely not be an issue, thus conserving processing and other resources on the device.

In some embodiments, the number of pixels to be skipped or includes in a pixel group can be determined based on information about the object being imaged as well. For example, for a head tracking application where the head is closer than about 1.5 meters, an effective resolution on the order of about 40×40 pixels might be sufficient. Similarly, basic gesture tracking can utilize resolutions on the order of about 40×40 pixels or less in at least some embodiments. For at least some situations, the maximum frame rate for a gesture sensor can be on the order of about 120 frames per second or more at full resolution, and higher at lower resolutions (i.e., 240 frames per second at 200×200 pixel resolution). Frame rates as low as about 7.5 frames per second can be supported in at least some embodiments in order to save power for scenarios such as those that do not require low-latency updates.

In some embodiments, a reduced resolution can be used to capture image data at a lower frame rate whenever a motion detection mode is operational on the device. The information captured from these pixels in at least some embodiments can be ratioed to detect relative changes over time. In one example, a difference in the ratio between pixels or groups of pixels (i.e., top and bottom, left and right, such as for a quad detector having an effective resolution of 2×2 pixels, or a 4×4 pixel detector) beyond a certain threshold can be interpreted as a potential signal to “wake up” the device. In at least some embodiments, a wake-up signal can generate a command that is sent to a central processor of the device to take the device out of a mode, such as sleep mode or another low power mode, and in at least some embodiments cause the gesture sensor to switch to a higher frame rate, higher resolution capture mode.

In at least some embodiments, the wake up signal causes the gesture sensor to capture information for at least a minimum period of time at the higher resolution and frame rate to attempt to determine whether the detection corresponded to an actual gesture or produced a false positive, such as may result from someone walking by or putting something on a shelf, etc. If the motion is determined to be a gesture to wake up the device, for example, the device can go into a gesture control mode that can be active until turned off, deactivated, a period of inactivity, etc. If no gesture can be determined, the device might try to locate a gesture for a minimum period of time, such as five or ten seconds, after which the device might go back to “sleep” mode and revert the gesture sensor back to the low frame rate, low resolution mode. The active gesture mode might stay active up to any appropriate period of inactivity, which might vary based upon the current activity. For example, if the user is reading an electronic book and typically only makes gestures upon finishing a page of text, the period might be a minute or two. If the user is playing a game, the period might be a minute or thirty seconds. Various other periods can be appropriate for other activities. In at least some embodiments, the device can learn a user's behavior or patterns, and can adjust the timing of any of these periods accordingly. It should be understood that various other motion detection approaches can be used as well, such as to utilize a traditional motion detector or light sensor, in other various embodiments. The motion detect mode using a small subset of pixel can be an extremely low power mode that can be left on continually in at least some modes or embodiments, without significantly draining the battery. In some embodiments, the power usage of a device can be on the order to microwatts for elements that are on continually, such that an example device can get around twelve to fourteen hours of use or more with a 1,400 milliwatt hour battery.

Another advantage of being able to treat the pixels as having electronic shutters is that there are at least some instances where it can be desirable to separate one or more features, such as a user's hand and/or fingers, from the background. For example, FIG. 6(a) illustrates an example image 600 representing a user's hand in front of a complex background image. Even at various resolutions, it can be relatively processor intensive to attempt to identify a particular feature in the image and follow this through subsequent images. For example, an image analysis algorithm would not only have to differentiate the hand from the door and sidewalk in the image, but would also have to identify the hand as a hand, regardless of the hand's orientation. Such an approach can require shape or contour matching, for example, which can still be relatively processor intensive. A less processor intensive approach would be to separate the hand from the background before analysis.

In at least some embodiments, a light emitting diode (LED) or other source of illumination can be triggered to produce illumination over a short period of time in which the pixels of the gesture sensor are going to be exposed. With a sufficiently fast virtual shutter, the LED will illuminate a feature close to the device much more than other elements further away, such that a background portion of the image can be substantially dark (or otherwise, depending on the implementation). For example, FIG. 6(b) illustrates an example image 610 wherein an LED or other source of illumination is activated (e.g., flashed or strobed) during a time of image capture of at least one gesture sensor. As can be seen, since the user's hand is relatively close to the device the hand will appear relatively bright in the image. Accordingly, the background images will appear relatively, if not almost entirely, dark. Such an image is much easier to analyze, as the hand has been separated out from the background automatically, and thus can be easier to track through the various images. Further, since the detection time is so short, there will be relatively little power drained by flashing the LED in at least some embodiments, even though the LED itself might be relatively power hungry per unit time. Such an approach can work both in bright or dark conditions. A light sensor can be used in at least some embodiments to determine when illumination is needed due at least in part to lighting concerns. In other embodiments, a device might look at factors such as the amount of time needed to process images under current conditions to determine when to pulse or strobe the LED. In still other embodiments, the device might utilize the pulsed lighting when there is at least a minimum amount of charge remaining on the battery, after which the LED might not fire unless directed by the user or an application, etc. In some embodiments, the amount of power needed to illuminate and capture information using the gesture sensor with a short detection time can be less than the amount of power needed to capture an ambient light image with a rolling shutter camera without illumination.

In instances where the ambient light is sufficiently high to register an image, it may be desirable to not illuminate the LEDs and use just the ambient illumination in a low-power ready-state. Even where the ambient light is sufficient, however, it may still be desirable to use the LEDs to assist in segmenting features of interest (e.g., fingers, hand, head, and eyes) from the background. In one embodiment, illumination is provided for every other frame, every third frame, etc., and differences between the illuminated and non-illuminated images can be used to help partition the objects of interest from the background.

As discussed, LED illumination can be controlled at least in part by strobing the LED simultaneously within a global shutter exposure window. The brightness of the LED can be modulated within this exposure window by, for example, controlling the duration and/or the current of the strobe, as long the strobe occurs completely within the shutter interval. This independent control of exposure and illumination can provide a significant benefit to the signal-to-noise ratio, particularly if the ambient-illuminated background is considered “noise” and the LED-illuminated foreground (e.g., fingers, hands, faces, or heads) is considered to be the “signal” portion. A trigger signal for the LED can originate on circuitry that is controlling the timing and/or synchronization of the various image capture elements on the device.

In at least some embodiments, however, it can be desirable to further reduce the amount of power consumption and/or processing that must be performed by the device. For example, it might be undesirable to have to capture image information continually and/or analyze that information to attempt to determine whether a user is providing gesture input, particularly when there has been no input for at least a minimum period of time.

Accordingly, systems and methods in accordance with various embodiments can utilize low power, low resolution gesture sensors to determine whether to activate various processors, cameras, or other components of the device. For example, a device might require that a user perform a specific gesture to “wake up” the device or otherwise cause the device to prepare for gesture-based input. In at least some embodiments, this “wake up” motion can be a very simple but easily detectable motion, such as waving the user's hand and arm back and forth, or swiping the user's hand from right to left across the user's body. Such simple motions can be relatively easy to detect using the low resolution, low power gesture sensors. In at least some embodiments, the detection of a wake-up gesture can cause a command to be sent to a central processor of the device to take the device out of a mode, such as sleep mode or another low power mode, and in at least some embodiments activate a higher resolution camera for a higher frame rate and/or higher resolution capture mode.

Another advantage of being able to treat the pixels as having electronic shutters is that there are at least some instances where it can be desirable to separate one or more features, such as a user's hand and/or fingers, from the background. Even at various resolutions, it can be relatively processor intensive to attempt to identify a particular feature in the image and follow this through subsequent images. A less processor-intensive approach would be to separate the hand from the background before analysis.

In at least some embodiments, a light emitting diode (LED) or other source of illumination can be triggered to produce illumination over a short period of time in which the pixels of the gesture sensor are going to be exposed. With a sufficiently fast virtual shutter, the LED will illuminate a feature close to the device much more than other elements further away, such that a background portion of the image can be substantially dark (or otherwise, depending on the implementation). Such an image is much easier to analyze, as the hand has been separated out from the background automatically, and thus can be easier to track through the various images. A light sensor can be used in at least some embodiments to determine when illumination is needed due at least in part to lighting concerns.

Another advantage to using low resolution gesture sensors is that the amount of image data that must be transferred is significantly less than for conventional cameras. Accordingly, a lower bandwidth bus can be used for the gesture sensors in at least some embodiments than is used for conventional cameras. For example, a conventional camera typically uses a bus such as a CIS (CMOS Image Sensor) or MIPI (Mobile Industry Processor Interface) bus to transfer pixel data from the camera to the host computer, application processor, central processing unit, etc. The combinations of resolutions and frame rates used by gesture sensors, as discussed herein, do not require a dedicated pixel bus such as a MIPI bus in at least some embodiments to connect to one or more processors, but can instead utilize much lower power buses, such as I²C (Inter-Integrated Circuit), SPI (Serial Peripheral Interface), and SD (secure digital) buses, among other general purpose, bi-directional serial buses and other such buses. These buses are typically not thought of as imaging buses, but are adequate for transferring the gesture sensor data for analysis, and more importantly can significantly reduce the power consumption for not only the camera data but also for the entire system, such as the bus interface on the host side. Furthermore, by using a common serial bus, processors that do not normally connect to cameras and do not have MIPI buses can be connected to these low-resolution gesture sensor cameras. For example, a PIC-class processor or microcontroller (originally a “peripheral interface controller”) is often used in mobile computing devices as a supervisor processor to monitor components such as power switches. A PIC processor can be connected over an I²C bus to a gesture camera, and the PIC processor can interpret the image data captured by the gesture sensors to recognize gestures such as “wake up” gestures.

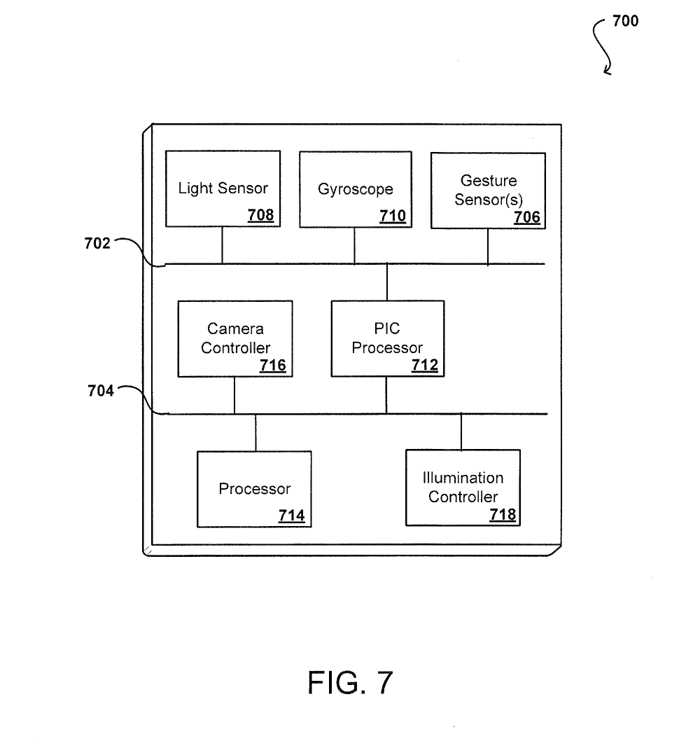

FIG. 7 illustrates an example configuration 700 of components of a computing device in accordance with at least one embodiment. In this example, one or more low power, low resolution gesture cameras 706, such as CMOS cameras configured as gesture sensors, can be used to capture image data. In some embodiments, a gesture camera might include one or more comparators built into the camera that can autonomously determine a difference spatially and/or temporally that might represent an event such as a gesture, and can cause an interrupt to be sent to an appropriate processor. In some embodiments the cameras can transmit the captured image data over a low bandwidth bus 702, such as an I²C bus, to a low power microprocessor, such as a PIC-class (micro)processor 712. In other embodiments, the image data can additionally and/or alternatively be transmitted to one or more application processors and/or supervisory processors, which might be separate from a main processor of the computing device. Such transmission can be performed using a MIPI bus or other such mechanism. As known for such devices, the PIC processor 712 can also communicate over the low bandwidth bus to components such as power switches (not shown), a light sensor 708, a motion sensor such as an accelerometer or gyroscope 710, and other such components. The gesture sensors can capture image data, and in response to at least a certain amount of detected variation can send the data over the low bandwidth bus 702 to the PIC processor 712, which can analyze the data to determine whether the motion or variation corresponds to a potential wake gesture, or other such input. If the PIC processor determines that the motion likely corresponds to a recognized gesture, the PIC processor can send data over a control bus 704 (e.g., a serial control bus like I²C) to a camera controller 716 to activate high resolution image capture, to an illumination controller 718 to provide illumination, or a main processor 714 (or application processor, etc.) to analyze the captured image data, among other such options. In some embodiments, the gesture sensor and/or high resolution camera (not shown) might communicate with the application processor using a MIPI bus, as discussed elsewhere herein. As discussed, the use of the lower bandwidth bus can provide a significant savings in power consumption with respect to higher bandwidth buses. The lower resolution gesture sensors also produce less data, which further saves processing and storage capacity, as well as consuming less power. In at least some embodiments, one or more commands can be sent to a user interface application executing on the computing device in response to detecting a gesture represented in the image data.

In some embodiments, a gesture sensor might utilize a pair of I²C buses, one for pixel data traffic and one for command traffic. Such an implementation enables commands to be sent even when the pixel bus is tied up with pixel traffic. In another embodiment, an SD bus can be used to send pixel data while an I²C bus can be used for the command traffic. In yet another embodiment, an I²C bus can be used to send command traffic to the gesture sensor, while a MIPI bus can be used to transfer image data. Various other configurations can be utilized as well within the scope of the various embodiments.

The PIC processor can also use other information to determine how to interpret the pixel data from the gesture sensor. The PIC can receive an interrupt that causes the PIC to interrogate the I²C bus in order to obtain pixel data from the gesture sensor registers. The PIC can analyze the stored data to determine if the registers are of a class that indicates further action needs to be taken, such as to analyze data from the gesture sensor, which might include a set of images in order to obtain history or motion data. The PIC processor can also utilize information from the light sensor 708 or gyroscope 710 (or compass, accelerometer, inertial sensor, etc.) to determine whether the device is likely in someone's pocket and/or whether detected movement was a result of the motion of the device. If the PIC detects a potential gesture and cannot determine whether the motion corresponds to a false alert, the PIC 712 can wake up the application processor 714, which can analyze image data to detect gestures or other such information. The PIC processor can analyze the data to determine when to perform other actions as well, such as to trigger a global shutter or global reset.

In some embodiments the gesture sensors can be synchronized in order to enable tracking of objects between fields of view of the gesture sensors. In one embodiment, synchronization commands can be sent over the I²C bus, or a dedicated line can be used to join the two sensors, in order to ensure synchronization.

In at least some embodiments, it can be desirable to further reduce the amount of power consumption and/or processing that must be performed by the device. For example, it might be undesirable to have to capture image information continually and/or analyze that information to attempt to determine whether a user is providing gesture input, particularly when there has been no input for at least a minimum period of time. Accordingly, systems and methods in accordance with various embodiments can utilize components of a gesture sub-assembly to determine whether to activate other components of the device. For example, a device might require that a user perform a specific gesture to “wake up” the device or otherwise cause the device to prepare for gesture-based input. In at least some embodiments, this “wake up” motion can be a very simple but easily detectable motion, such as waving the user's hand and arm back and forth, or swiping the user's hand from right to left across the user's body. Such simple motions can be relatively easy to detect even in very low resolution images.

In at least some embodiments, it can be desirable for the gesture sensor, LED trigger, and other such elements to be contained on the chip of the gesture sensor. In at least some embodiments, a gesture sensor is a system-on-chip (“SOC”) camera, color or monochrome, with the timing signals for the exposure of the pixels and the signal for the LED being generated on-chip, whereby the illumination from the LED can be synchronized with the exposure time. By including various components and functionality on the camera chip, there may be no need in at least certain situations to utilize upstream processors of the device, which can help to save power and conserve resources. For example, certain devices utilize 5-10 milliwatts simply to wake up the bus and communicate with a central processor. By keeping at least part of the functionality on the camera chip, the device can avoid the system bus and thus reduce power consumption.

Various on-die control and image processing functions and circuitry can be provided in various embodiments. In one embodiment, at least some system-level control and image processing functions can be located the same die as the pixels. Such SOC functions enable the sensor and related components to function as a camera without accessing external control circuitry, principally sourcing of clocks to serially read out the data including options for decimation (skipping pixels, or groups of pixels during readout), binning (summing adjacent groups of pixels), windowing (limiting serial readout to a rectangular region of interest), combinations of decimation and windowing, aperture correction (correction of the lens vignetting), and lens correction (correction of the lens geometric distortion, at least the radially symmetric portion). Other examples of on-die image-processing functions include “blob” or region detection for segmenting fingers for hand gestures and face detection and tracking for head gestures. Various other types of functionality can be provided on the camera chip as well in other embodiments.

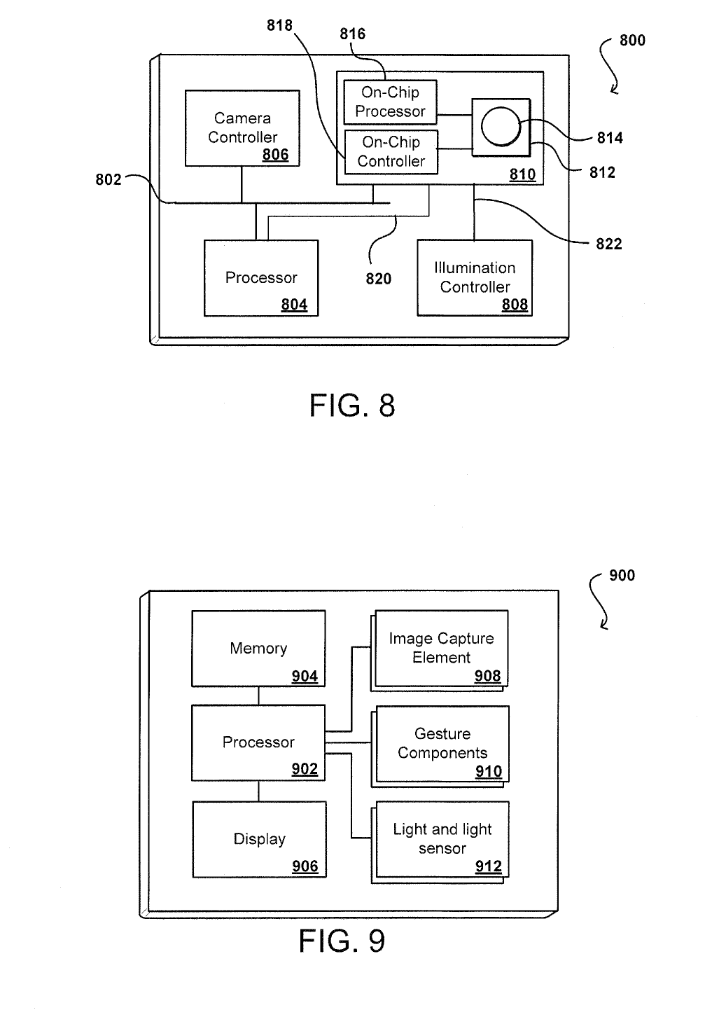

In one example, FIG. 8 illustrates a configuration 800 wherein at least some processing 816 and controlling 818 components are provided on the chip 810 with the gesture sensor 812, optical elements 814 (e.g., lenses or optical filters), and other such components. As discussed, such placement enables certain functionality to be executed without need to access a system bus 802, central processor 804, or other such element. As discussed elsewhere herein, such functionality can also be utilized to control various other components, such as a camera controller 806, illumination controller 808, or other such element. It should be understood, however, that elements such as the illumination controller 808 can alternatively (or additionally) be located on-chip as well in certain embodiments.

In some embodiments, a companion chip can be utilized for various timing control and image processing functions. Alternatively, functions related to timing generation, strobe control, and some image processing functions can be implemented on a companion chip such as an FPGA or an ASIC. Such an approach permits altering, customizing, or updating functions in the companion chip without affecting the gesture sensor chip.

At least some embodiments can utilize an on-die, low-power wake-up function. In a low power mode, for example, the imager could operate at a predetermined or selected resolution (typically a low resolution such as 4 or 16 or 36 pixels) created by selectively reading pixels in a decimation mode. Optionally, blocks of pixels could be binned for higher sensitivity, each block comprising one of the selected pixels. The imager could operate at a predetermined or selected frame-rate, typically a lower than a video frame rate (30 fps), such as 6 or 3 or 1.5 fps. The commands to enter a low power mode can be received from a component such as a host processor 804, application processor, or other such component over a command line 820, which in at least some embodiments can include an I²C bus for transmitting control traffic to the camera subsystem. If binning is utilized, circuitry around the edge of the pixels of the gesture sensor 812 can be used to sum and average the pixel values of a respective pixel group. As discussed, at least some embodiments allow for different resolutions, such as 200×200, 100×100, 50×50 pixel resolutions.

One reason for operating the imager in low resolution and at low frame rates is to maximally conserve battery power while in an extended standby-aware mode. In such a mode, groups of pixels can be differentially compared, as discussed, and when the differential signal changes by an amount exceeding a certain threshold within a certain time the gesture chip circuitry can trigger a wakeup command, such as by asserting a particular data line high. The command also can be sent to the processor 804 over the I²C bus, along with other configuration or operational data or instructions. This line can wake up a “sleeping” central processor which could then take further actions to determine if the wake-up signal constituted valid user input or was a “false alarm.” Actions could include, for example, listening and/or putting the cameras into a higher-resolution and/or higher frame-rate mode and examining the images for valid gestures or faces. In at least some embodiments, the processor can request or receive image data captured by the gesture sensor 812 over a dedicated, single lane MIPI bus 820. The processor in at least some embodiments can perform additional processing on the data in order to attempt to make a more accurate determination as to whether a specific motion or gesture was performed. The additional processing and/or at least some of these actions can be beyond the capability of the on-die processing of conventional cameras. If the input is valid, appropriate action can be taken, such as turning on a display, turning on an LED, entering a particular mode, etc. If the input is determined to be a false alarm, the central processor can re-enter the sleep state and the cameras can re-enter (or remain in) a standby-aware mode.

If deemed necessary, such as where the overall scene brightness is too low, the on-die camera circuitry can also trigger an LED illuminator to fire within the exposure interval of the camera. In at least some embodiments, the LED can be an infrared (IR) LED to avoid visible flicker that can be distracting to users, as IR LEDs are invisible to people above a certain wavelength. In such an embodiment, the gesture sensor can be operable to detect light at least partially at infrared or near-infrared wavelengths. The sensor sub-assembly in this case includes a dedicated line 822 to the illumination controller, in order to synchronize the illumination from the IR LED with the global shutter exposure of the pixels of the gesture sensor 812. The duration of the LED strobe in at least some embodiments can be less than the duration of the global shutter exposure, as discussed elsewhere herein. In some embodiments IR illumination might be used even when there is sufficient ambient lighting, such as where it is desired to quickly separate an object in the foreground from a busy background. The illumination might be reflected up to about a quarter of a meter or so in some embodiments, and everything else in the image can appear dark, as discussed above. The commands sent over the dedicated line 822 can control the beginning and end of the strobe, allowing the illumination to be implicitly synchronized with the camera shutter.

In order to provide various functionality described herein, FIG. 9 illustrates an example set of basic components of a computing device 900, such as the device 104 described with respect to FIG. 1. In this example, the device includes at least one central processor 902 for executing instructions that can be stored in at least one memory device or element 904. As would be apparent to one of ordinary skill in the art, the device can include many types of memory, data storage or computer-readable storage media, such as a first data storage for program instructions for execution by the processor 902, the same or separate storage can be used for images or data, a removable storage memory can be available for sharing information with other devices, etc. The device typically will include some type of display element 906, such as a touch screen, electronic ink (e-ink), organic light emitting diode (OLED) or liquid crystal display (LCD), although devices such as portable media players might convey information via other means, such as through audio speakers. In at least some embodiments, the display screen provides for touch or swipe-based input using, for example, capacitive or resistive touch technology.

As discussed, the device in many embodiments will include at least one image capture element 908, such as one or more cameras that are able to image a user, people, or objects in the vicinity of the device. The device can also include at least one separate gesture sensor 910 operable to capture image information for use in determining gestures or motions of the user, which will enable the user to provide input through the portable device without having to actually contact and/or move the portable device. An image capture element can include, or be based at least in part upon any appropriate technology, such as a CCD or CMOS image capture element having a determine resolution, focal range, viewable area, and capture rate. As discussed, various functions can be included on with the gesture sensor or camera device, or on a separate circuit or device, etc. A gesture sensor can have the same or a similar form factor as at least one camera on the device, but with different aspects such as a different resolution, pixel size, and/or capture rate. While the example computing device in FIG. 1 includes one image capture element and one gesture sensor on the “front” of the device, it should be understood that such elements could also, or alternatively, be placed on the sides, back, or corners of the device, and that there can be any appropriate number of capture elements of similar or different types for any number of purposes in the various embodiments. The device also can include at least one lighting element 912, as may include one or more illumination elements (e.g., LEDs or flash lamps) for providing illumination and/or one or more light sensors for detecting ambient light or intensity.

The example device can include at least one additional input device able to receive conventional input from a user. This conventional input can include, for example, a push button, touch pad, touch screen, wheel, joystick, keyboard, mouse, trackball, keypad or any other such device or element whereby a user can input a command to the device. These I/O devices could even be connected by a wireless infrared or Bluetooth or other link as well in some embodiments. In some embodiments, however, such a device might not include any buttons at all and might be controlled only through a combination of visual (e.g., gesture) and audio (e.g., spoken) commands such that a user can control the device without having to be in contact with the device.

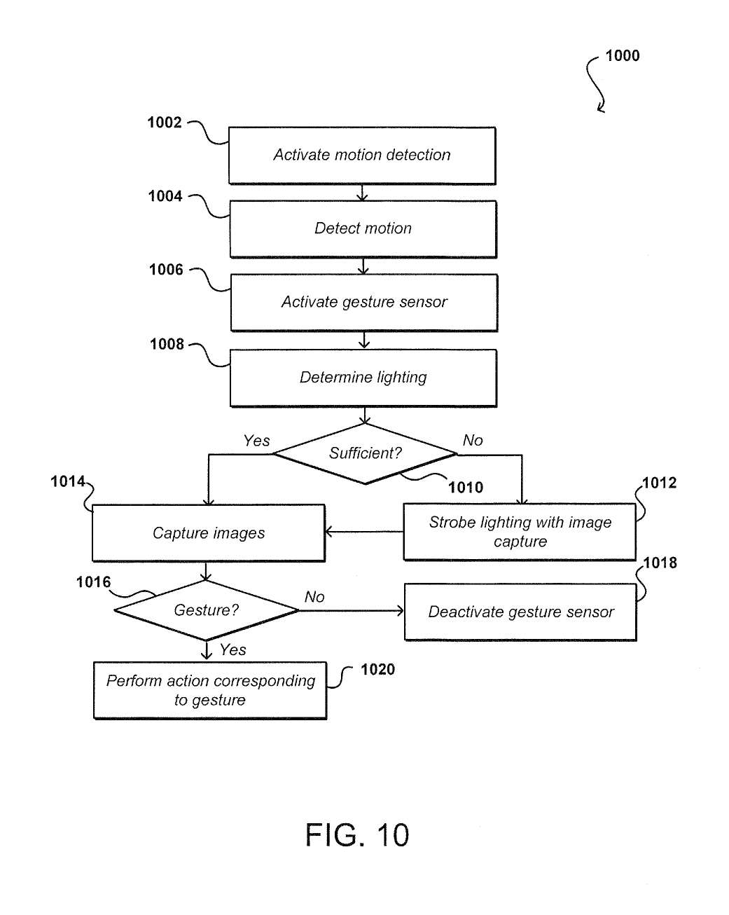

FIG. 10 illustrates an example process for enabling gesture input for such a computing device that can be used in accordance with various embodiments. It should be understood that, for any process discussed herein, there can be additional, fewer, or alternative steps performed in similar or alternative orders, or in parallel, within the scope of the various embodiments unless otherwise stated. In this example, a motion detection mode is activated on the computing device 1002. In some embodiments, the motion detection mode can automatically be turned on whenever the computing device is active, even in a sleep mode or other such low power state. In other embodiments, the motion detection mode is activated automatically upon running an application or manually upon user selection. Various other activation events can be utilized as well. As discussed elsewhere herein, in at least some embodiments the motion detection is provided by utilizing a small set of pixels of a gesture sensor and using a comparator or similar process to determine various types or patterns of relative motion. When the portion of the gesture sensor detects changes that likely correspond to motion 1004, the gesture sensor can be activated for gesture input 1006. In embodiments where the motion detection utilizes a subset of the gesture sensor pixels, this can involve activating the remainder of the pixels, adjusting a frame rate, executing different instructions, etc. In at least some embodiments, a detecting of motion causes a signal to be sent to a device processor, which can generate an instruction causing the gesture sensor to go into a higher resolution mode or other such state. Such an embodiment can require more power than an on-chip approach in at least some embodiments, but because the processor takes a minimum amount of time to warm up, such an approach can help to ensure that there is no degradation of image quality when an image is captured that might otherwise occur if the image must wait for the processor to warm up before being processed. When a gesture input mode is activated, a notification can be provided to the user, such as by lighting an LED on the device or displaying a message or icon on a display screen. In at least some embodiments, the device will also attempt to determine an amount of ambient lighting 1008, such as by using at least one light sensor or analyzing the intensity of the light information captured by the subset of pixels during motion detection.

If the amount of ambient light (or light from an LCD screen, etc.) is not determined to be sufficient 1010, at least one illumination element (e.g., an LED) can be triggered to strobe at times and with periods that substantially correspond with the capture times and windows of the gesture sensor 1012. In at least some embodiments, the LED can be triggered by the gesture sensor chip. If the illumination element is triggered or the ambient light is determined to be sufficient, a series of images can be captured using the gesture sensor 1014. The images can be analyzed using an image recognition or gesture analysis algorithm, for example, to determine whether the motion corresponds to a recognizable gesture 1016. If not, the device can deactivate the gesture input mode and gesture sensor and return to a low power and/or motion detection mode 1018. If the motion does correspond to a gesture, an action or input corresponding to that gesture can be determined and utilized accordingly. In one example, the gesture can cause a camera element of the device to be activated for a process such as facial recognition, where that camera has a similar form factor to that of the gesture sensor, but a higher resolution and various other differing aspects. In some embodiments, the image information captured by the gesture sensor is passed to a system processor for processing when the gesture sensor is in full gesture mode, with the image information being analyzed by the system processor. In such an embodiment, only the motion information is analyzed on the camera chip. Various other approaches can be used as well as discussed or suggested elsewhere herein.

In at least some embodiments, a gesture sensor can have a wider field of view (e.g., 120 degrees) than a high resolution camera element (e.g., 60 degrees). In such an environment, the gesture sensor can be used to track a user who has been identified by image recognition but moves outside the field of view of the high resolution camera (but remains within the field of view of the gesture sensor). Thus, when a user re-enters the field of view of the camera element there is no need to perform another facial recognition, which can conserve resources on the device.

Various embodiments also can control the shutter speed for various conditions. In some embodiments, the gesture sensor might have only have one effective “shutter” speed, such as may be on the order of about one millisecond in order to effectively freeze the motion in the frame. In at least some embodiments, however, the device might be able to throttle or otherwise adjust the shutter speed, such as to provide a range of exposures under various ambient light conditions. In one example, the effective shutter speed might be adjusted to 0.1 milliseconds in bright daylight to enable to the sensor to capture a quality image. As the amount of light decreases, such as when the device is taken inside, the shutter might be adjusted to around a millisecond or more. There might be a limit on the shutter speed to prevent defects in the images, such as blur due to prolonged exposure. If the shutter cannot be further extended, illumination or other approaches can be used as appropriate. In some embodiments, an auto-exposure loop can run local to the camera chip, and can adjust the shutter speed and/or trigger an LED or other such element as necessary. In cases where an LED, flashlamp, or other such element is fired to separate the foreground from the background, the shutter speed can be reduced accordingly. If there are multiple LEDs, such as one for a camera and one for a gesture sensor, each can be triggered separately as appropriate.

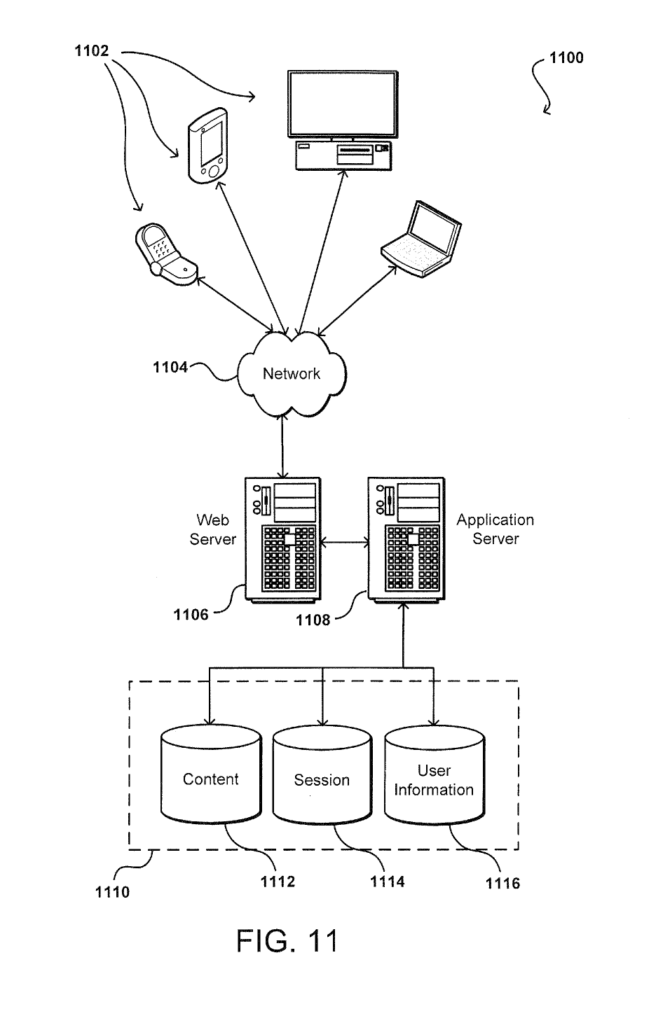

As discussed, different approaches can be implemented in various environments in accordance with the described embodiments. For example, FIG. 11 illustrates an example of an environment 1100 for implementing aspects in accordance with various embodiments. As will be appreciated, although a Web-based environment is used for purposes of explanation, different environments may be used, as appropriate, to implement various embodiments. The system includes an electronic client device 1102, which can include any appropriate device operable to send and receive requests, messages or information over an appropriate network 1104 and convey information back to a user of the device. Examples of such client devices include personal computers, cell phones, handheld messaging devices, laptop computers, set-top boxes, personal data assistants, electronic book readers and the like. The network can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled via wired or wireless connections and combinations thereof. In this example, the network includes the Internet, as the environment includes a Web server 1106 for receiving requests and serving content in response thereto, although for other networks, an alternative device serving a similar purpose could be used, as would be apparent to one of ordinary skill in the art.

The illustrative environment includes at least one application server 1108 and a data store 1110. It should be understood that there can be several application servers, layers or other elements, processes or components, which may be chained or otherwise configured, which can interact to perform tasks such as obtaining data from an appropriate data store. As used herein, the term “data store” refers to any device or combination of devices capable of storing, accessing and retrieving data, which may include any combination and number of data servers, databases, data storage devices and data storage media, in any standard, distributed or clustered environment. The application server 1108 can include any appropriate hardware and software for integrating with the data store 1110 as needed to execute aspects of one or more applications for the client device and handling a majority of the data access and business logic for an application. The application server provides access control services in cooperation with the data store and is able to generate content such as text, graphics, audio and/or video to be transferred to the user, which may be served to the user by the Web server 1106 in the form of HTML, XML or another appropriate structured language in this example. The handling of all requests and responses, as well as the delivery of content between the client device 1102 and the application server 1108, can be handled by the Web server 1106. It should be understood that the Web and application servers are not required and are merely example components, as structured code discussed herein can be executed on any appropriate device or host machine as discussed elsewhere herein.

The data store 1110 can include several separate data tables, databases or other data storage mechanisms and media for storing data relating to a particular aspect. For example, the data store illustrated includes mechanisms for storing content (e.g., production data) 1112 and user information 1116, which can be used to serve content for the production side. The data store is also shown to include a mechanism for storing log or session data 1114. It should be understood that there can be many other aspects that may need to be stored in the data store, such as page image information and access rights information, which can be stored in any of the above listed mechanisms as appropriate or in additional mechanisms in the data store 1110. The data store 1110 is operable, through logic associated therewith, to receive instructions from the application server 1108 and obtain, update or otherwise process data in response thereto. In one example, a user might submit a search request for a certain type of item. In this case, the data store might access the user information to verify the identity of the user and can access the catalog detail information to obtain information about items of that type. The information can then be returned to the user, such as in a results listing on a Web page that the user is able to view via a browser on the user device 1102. Information for a particular item of interest can be viewed in a dedicated page or window of the browser.

Each server typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 11. Thus, the depiction of the system 1100 in FIG. 11 should be taken as being illustrative in nature and not limiting to the scope of the disclosure.

The various embodiments can be further implemented in a wide variety of operating environments, which in some cases can include one or more user computers or computing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially-available operating systems and other known applications for purposes such as development and database management. These devices can also include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP, OSI, FTP, UPnP, NFS, CIFS and AppleTalk. The network can be, for example, a local area network, a wide-area network, a virtual private network, the Internet, an intranet, an extranet, a public switched telephone network, an infrared network, a wireless network and any combination thereof.

In embodiments utilizing a Web server, the Web server can run any of a variety of server or mid-tier applications, including HTTP servers, FTP servers, CGI servers, data servers, Java servers and business application servers. The server(s) may also be capable of executing programs or scripts in response requests from user devices, such as by executing one or more Web applications that may be implemented as one or more scripts or programs written in any programming language, such as Java®, C, C# or C++ or any scripting language, such as Perl, Python or TCL, as well as combinations thereof. The server(s) may also include database servers, including without limitation those commercially available from Oracle®, Microsoft®, Sybase® and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system may also include one or more storage devices, such as disk drives, optical storage devices and solid-state storage devices such as random access memory (RAM) or read-only memory (ROM), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A computing device, comprising:
a device processor;
an illumination element;
a camera sensor; and
a gesture subsystem including at least:
a gesture sensor capable of capturing image data, the gesture sensor having a lower number of pixels than the camera sensor, the gesture sensor further having a larger pixel pitch than the camera sensor;
a command bus enabling the gesture subsystem to receive command input from the device processor;
a gesture processor configured to analyze the image data captured by the gesture sensor, the gesture processor configured to recognize a pattern in the image data; and
an image data bus enabling the gesture subsystem to transfer at least a portion the image data to the device processor,
wherein the gesture subsystem is configured to contact the device processor upon a pattern being recognized by the gesture processor.

2. The computing device of claim 1, wherein the gesture subsystem is configured to selectively operate in a normal resolution mode, wherein all of the pixels are read and analyzed individually, and at least one lower resolution mode.

3. The computing device of claim 2, wherein in one of the at least one lower resolution mode the gesture processor analyzes the image data for only a portion of the pixels of the gesture sensor, the portion being determined based at least in part upon at least one command received over the command bus.

4. The computing device of claim 2, wherein in one of the at least one lower resolution mode the gesture processor analyzes the image data for groups of pixels of the gesture sensor, the number of pixels in a group being determined based at least in part upon at least one command received over the command bus.

5. The computing device of claim 4, wherein analyzing the groups of pixels includes determining an average value based at least in part upon the pixel data for each pixel in a group.

6. The computing device of claim 1, wherein each of the pixels of the gesture sensor is configured to capture the image data at substantially the same exposure time, and wherein each pixel of the gesture sensor has an associated storage for storing the pixel data captured by the pixel until the pixel data can be read by the gesture subsystem.

7. The computing device of claim 1, wherein the pattern corresponds to at least one of head movement, object movement, or gesture movement.

8. The computing device of claim 1, wherein the gesture subsystem further comprises an illumination output for sending timing data to an illumination element controller, the timing data causing a synchronized activation of the illumination element with the capturing of image data by the gesture sensor.

9. The computing device of claim 8, wherein the illumination element comprises an infrared light emitting diode.

10. The computing device of claim 8, wherein the illumination element is activated to provide illumination during at least a portion of the exposure time.

11. The computing device of claim 1, wherein the gesture sensor further includes a Bayer color filter.

12. The computing device of claim 1, wherein the pixel pitch of the gesture sensor is at most approximately three microns.

13. The computing device of claim 1, wherein a maximum resolution of the gesture sensor is four hundred by four hundred pixels.

14. The computing device of claim 1, wherein the command bus is an inter-integrated circuit (I²C) bus.

15. The computing device of claim 1, wherein the image data bus is a single lane Mobile Industry Processor Interface (MIPI) interface.

16. The computing device of claim 1, wherein the maximum frame rate of the gesture sensor is at least one-hundred twenty frames per second at full resolution.

17. The computing device of claim 1, wherein the computing device includes at least one additional gesture subsystem, the computing device capable of selectively activating one or more of the at least one additional gesture subsystem on the device.

18. The computing device of claim 1, further comprising:
memory including instructions that, when executed by the device processor, further cause the device processor to obtain at least a portion of the image data captured by the gesture sensor over the image data bus when the pattern is recognized by the gesture processor, the instructions further causing the device to analyze the image data and activate the camera sensor in response to verifying the pattern in the image data.

19. The computing device of claim 18, wherein verifying the pattern includes analyzing data from at least one other device sensor on the computing device.

20. The computing device of claim 1, wherein the gesture processor receives the image data from the gesture sensor over a lower power bus than the image data bus.

21. A gesture subsystem, comprising:
a gesture sensor capable of capturing image data;
a command bus enabling the gesture subsystem to receive command input;
a gesture processor configured to analyze the image data captured by the gesture sensor, the gesture processor configured to recognize a pattern in the image data; and
an image data bus enabling the gesture sensor to transfer the image data captured by the gesture sensor,
wherein the gesture subsystem is configured to contact at least one of a device processor or a camera of a computing device upon a pattern being recognized by the gesture processor.

22. The gesture subsystem of claim 21, wherein the gesture processor receives the image data from the gesture sensor over a lower power bus than the image data bus.

23. The gesture subsystem of claim 21, wherein the gesture sensor has a lower number of pixels, and a larger pixel pitch, than the camera.

24. The gesture subsystem of claim 21, wherein each of the pixels of the gesture sensor is configured to capture the image data at substantially the same exposure time, each pixel of the gesture sensor having an associated storage for storing the pixel data captured by the pixel until the pixel data is read for analysis.

25. The gesture subsystem of claim 21, wherein the gesture subsystem is configured to operate in a normal resolution mode, wherein all of the pixels are read and analyzed individually, and at least one lower resolution mode,
wherein in one of the at least one lower resolution mode the gesture processor analyzes image data for only a portion of the pixels of the gesture sensor, the portion being determined based at least in part upon at least one command received over the command bus, and
wherein in one of the at least one lower resolution mode the gesture processor analyzes groups of pixels of the gesture sensor, the number of pixels in a group being determined based at least in part upon at least one command received over the command bus.

26. The gesture subsystem of claim 21, further comprising:
an illumination output for sending commands to syncrhonize an activation of an illumination element with the capturing of image data by the gesture sensor.

27. A non-transitory computer-readable storage medium including instructions that, when executed by at least one processor of a computing device, cause the computing device to:
determine at least one imaging condition;
determine an operational mode for a gesture subsystem of the computing device based at least in part upon the at least one imaging condition;
capture at least one image using a gesture sensor of the gesture subsystem, the gesture sensor including a number of pixels each capturing pixel data for the at least one image;
analyze the pixel data for each of the number of pixels of the gesture sensor when the selected operational mode is a normal operational mode;
analyze the pixel data for a subset of the number of pixels of the gesture sensor when the selected operational mode is a first lower resolution mode;
analyze the pixel data for groups of the number of pixels of the gesture sensor when the selected operational mode is a second lower resolution mode; and
contact a device processor of the computing device when a pattern is recognized from analyzing the pixel data.

28. The non-transitory computer-readable storage medium of claim 27, wherein the at least one imaging condition is an amount of light detected by a light sensor of the computing device.

29. The non-transitory computer-readable storage medium of claim 27, wherein the instructions when executed further cause the computing device to:
cause the number of pixels of the gesture sensor to each capture respective pixel data at approximately the same exposure time.
